(19) United States
(12) Patent Application Publication
(10) Pub. No.: US 2007/0170247 A1
(43) Pub. Date: Jul. 26, 2007

(54) Payment card authentication system and method

(76) Inventor: Maury Samuel Friedman, Agoura Hills, CA (US)

Correspondence Address: YING CHEN, 255 S. GRAND AVE., # 215, LOS ANGELES, CA, 90012, US

(21) Appl. No.: 11/522,032

(22) Filed: Sep. 14, 2006

Related U.S. Application Data
(60) Provisional application No. 60/760,522, filed on Jan. 20, 2006.

(51) Int. Cl. G06K 5/00; G07F 19/00; G06Q 40/00

(52) U.S. Cl. 235/380; 235/379; 705/44

(57) ABSTRACT

A system and method for authenticating payments are described. In a registration and activation step, an issuer issues to a user one or more patterns of digit substitution associated with a permanent account number. The patterns of digit substitution can then be used to generate derivative account numbers based on the permanent account number. During a commerce transaction, the user interacts with a merchant and specifies a derivative account number. The merchant transmits the derivative account number and other transaction information to the issuer for approval. Based on the derivative account number, the issuer retrieves the permanent account number and processes an approval. By using this method, a user's actual permanent account number is not revealed or transmitted via an unsecure network, which protects it from being stolen. The method may be used in various transactions to protect other personal identification information such as social security numbers, driver license numbers, etc.

This application claims priority from U.S. Provisional Patent Application No. 60/760,522, filed Jan. 20, 2006, which is herein incorporated by reference in its entirety.

### BACKGROUND OF THE INVENTION

1. Field of the Invention

The present invention relates, in general, to method and system for protecting personal identification information from fraudulent usage, and in particular, it relates to payment card authentication systems and methods.

2. Description of the Related Art

Protection of personal identification information such as payment card numbers is a major concern in e-commerce. Methods and systems have been developed to attempt to protect such information from being stolen or misused. Some of methods that try to protect payment card numbers make use of a temporary transaction number that resembles an actual payment card number, and use the temporary number in on-line commerce. For example, U.S. Pat. No. 5,883,810 to Franklin et al., entitled “Electronic online commerce card with transaction proxy number for online transactions,” describes “[a]n online commerce system [that] facilitates online commerce over a public network using an online commerce card. The ‘card’ does not exist in physical form, but instead exists in digital form. The online commerce card is issued electronically to a customer by an issuing institution. The issued card is assigned a permanent customer account number that is maintained on behalf of the customer at the issuing institution to remove the risk of the number being lost or s stolen. When the customer desires to conduct an online transaction, the customer asks the issuing institution to issue a transaction number for a single transaction. The issuing institution generates a temporary transaction number and associates it with the permanent account number in a data record. The customer receives the transaction number and submits that number to the merchant as a proxy for the customer account number. The transaction number looks like a real card number and the merchant handles the transaction number in the same manner as any regular credit card number. When the merchant submits an request for authorization, the issuing institution recognizes the number as a transaction number for an online commerce card. The issuing institution references the customer account number, using the transaction number as an index, and processes the authorization request using the real customer account number in place of the proxy number. Once the authorization request is processed, the issuing institution once again exchanges the transaction number for the customer account number and sends an authorization reply back to the merchant under the transaction number.” (Abstract.) One disadvantage of such a system is that it is cumbersome to use because a temporary transaction number has to be obtained for every transaction.

U.S. Patent Application Publication No. 20020007320 describes a “method of conducting a financial transaction by a purchaser over a communications network . . . where the purchaser does not transmit his or her ‘real’ payment card information over the network but instead secure payment application software is provided which allows for the transmission of a pseudo account number that is cryptographically processed for purposes of responding to an authorization request based on the real account number.” (Abstract.) A disadvantage of this method is that it requires special software (secure payment application which includes a secret cryptographic key unique to the card) on the user's computer (see Paragraph 0025).

### SUMMARY OF THE INVENTION

The present invention is directed to a system and method of authenticating payment cards that substantially obviate one or more of the problems due to limitations and disadvantages of the related art.

An object of the present invention is to provide a system and method for authenticating payment cards that are secure and easy to use.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method for authenticating payments, which includes: an issuer issuing to a user one or more patterns of digit substitution associated with a permanent account number and storing the patterns of digit substitution; the user generating a derivative account number by applying one of the patterns of digit substitution to the permanent account number; the user transmitting the derivative account number to a merchant; the merchant transmitting the derivative account number and transaction information to the issuer for approval; and based on the received derivative account number, the issuer retrieving stored information for the corresponding permanent account number and processing an approval.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a payment card authentication system according to an embodiment of the present invention.

FIG. 2 illustrates a payment card authentication method according to an embodiment of the present invention.

### DETAILED DESCRIPTION OF THE PREFERRED EMBODIMENTS

The aspects, features and advantages of the present invention will become better understood with reference to the following descriptions and the accompanying drawings. What follows are preferred embodiments of the present invention. It should be apparent to those skilled in the art that the descriptions are illustrative only and not limiting and are presented by way of example only. All the features disclosed in this description may be replaced by alternative or equivalent features serving the same purpose. The method and system may be applied to protect not only payment card numbers, but also other personal identification information including but not limited to social security numbers, driver license numbers, etc. Therefore, numerous other embodiments and modifications thereof are contemplated as falling within the scope of the present invention.

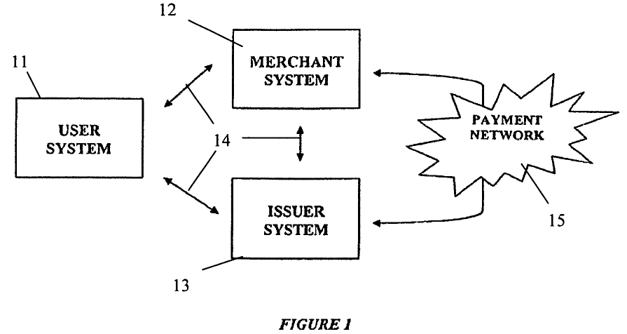

FIG. 1 illustrates a payment card authentication system according to an embodiment of the present invention. As shown, the payment card authentication system generally includes one or more user systems 11, one or more merchant systems 12, one or more issuer systems 13 and one or more communications pathways 14 for connecting the various systems. The user systems 11 may comprise any form of network enabled devices. Suitable examples include telephonic devices, computing systems including stationary computing devices such as desktops and workstations, and portable computing devices such as laptops and handheld devices. The merchant systems 12 and issuer systems 13 may comprise any computing systems, such as desktops, workstations, mainframes, etc. The communication pathways 14 may comprise any form of data communication network that links two or more systems together. Suitable examples include, but are not limited to, LAN and WAN networks, the Internet or other global area network, VAN, POTS networks and cable, television, satellite and wireless networks, etc. The merchant systems may separately be connected to the issuer systems via a secure payment network 15 specifically adapted for payment card transactions and other types of financial/banking transactions. A suitable example of a secure payment network is the VISANET global payment network by Visa USA.

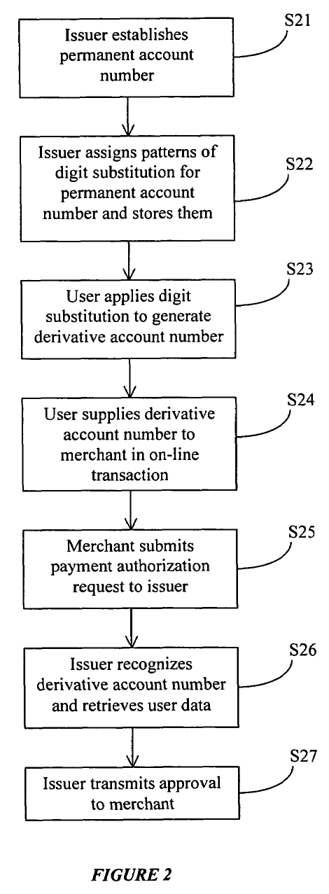

FIG. 2 illustrates a method of payment card authentication according to an embodiment of the present invention. First, a user acquires a permanent payment account from an issuer by applying for a permanent account via conventional application methods. After user verification and approval, the issuer establishes a user account data record at the issuer, creates a permanent payment card for the user and assigns a permanent account number to the permanent payment card (step S21). Additionally, the issuer creates one or more patterns of digit substitution for the digits of the permanent account number and associates the patterns with the permanent account number (step S22). For example, a digit substitution pattern may specify that the 7th digit of the permanent account number, which is a “4”, is to be substituted by a digit “2”. A digit substitution pattern may also substitute two or more digits of the permanent account number, but a one-digit substitution is typically sufficient. The digit substitution patterns may be generated by the issuer using a random number generator. The issuer stores the user's permanent account number and the one or more digit substitution patterns in a user account data record. Note that the digit substitution patterns may be stored by storing the patterns themselves or by storing the account numbers after the digits have been substituted. The user receives the permanent payment card with the permanent account number, typically, embossed thereon and stored in a magnetic stripe. The user is also informed of the digit substitution patterns. Steps S21 and S22 may be referred to as the registration and activation step. In addition to new applications for payment cards, the above process/system is also applicable to existing card holders (users). In other words, digit substitution patterns may be created for payment cards that have already been issued.

Such a card can be used for both the traditional types of transactions and on-line commerce transactions. In payment transactions that involve the presentation of the physical card, such as transactions at point of sale locations, the user uses the physical permanent payment card bearing the permanent account number. When conducting on-line commerce transactions, transactions over the telephone, or other selected types of transactions such as overseas commerce transactions, transactions involving large monetary amounts, transactions that may be transmitted over unsecure networks, etc., the user applies an appropriate digit substitution pattern to the permanent account number to generate a temporary or derivative account number, and uses the derivative account number as the payment account number for the transaction. Optionally, the issuer and user may pre-establish a plurality of digit substitution patterns to be used for different types of transactions. For example, one digit substitution pattern may be used for overseas transactions, another for transactions involving amounts over a certain limit, etc. The user may have the option to periodically change the digit substitution patterns by contacting the issuer either telephonically or electronically (using email, website, SMS messages, etc.).

For added security, the user and issuer may place restrictions on the use of the derivative numbers, e.g., expiration of a derivative number after a certain time period, restriction on the use of a derivative numbers to a predefined maximum number of transactions, etc.

When the user conducts an online commerce transaction, or another type of transaction for which the derivative account number is to be used such as where payment card numbers are either manually entered or spoken as opposed to being read by a magnetic card reader, the user applies an appropriate digit substitution pattern to the permanent account number to generate a derivative account number (step S23). For example, the user substitutes the 7th digit of the permanent account number, which is a “4”, with a digit “2”. The user transmits the derivative account number over the communication pathways to the merchant for processing (step S24). After receiving the derivative account number from the user, the merchant submits a payment authorization to the card issuer for approval (step S25). The authorization request contains the user's derivative account number and other data specific to the transaction. The merchant's system is unaware that it is receiving a derivative account number because the number resembles an actual permanent account number (such as a credit card number). The card issuer identifies the number as a derivative account number and retrieves the user's data record based on the derivative account number (step S26). After matching certain information stored in the user's data record with information contained in the authorization request, the card issuer approves the authorization request and notifies the merchant of the approval (step S27). When processing the approval, the issuer takes into consideration any restrictions associated with the derivative account number. Steps S25, S26 and S27 collectively constitutes the payment authorization step.

An advantage of the system and method described herein is that they help prevent a stolen permanent card number from being used by unauthorized persons in on-line or other transactions. For example, permanent card numbers may be stolen if the physical card is lost or stolen, or if a receipt bearing the permanent card number is obtained by unauthorized persons. If an unauthorized person attempts to conduct an on-line transaction using the permanent payment card number, the issuer system will recognize it as an authorized transaction because the authorized user is expected to use a derivative account number for on-line transactions.

Another advantage of the method described herein is that it is convenient and easy to use. The digit substitution patterns are easy to memorize and a user can typically make the correct digit substitution without having to look it up. Further, it does not require any special software on the user's computer.

As pointed out earlier, the system and method may be used in various transactions to protect other personal identification information such as social security numbers, driver license numbers, etc.

It will be apparent to those skilled in the art that various modification and variations can be made in the system and method of the present invention without departing from the spirit or scope of the invention. Thus, it is intended that the present invention cover modifications and variations that come within the scope of the appended claims and their equivalents.

What is claimed is:

1. A method for authenticating payments comprising:
an issuer issuing to a user one or more patterns of digit substitution associated with a permanent account number and storing the patterns of digit substitution;
the user generating a derivative account number by applying one of the patterns of digit substitution to the permanent account number;
the user transmitting the derivative account number to a merchant;
the merchant transmitting the derivative account number and transaction information to the issuer for approval; and
based on the received derivative account number, the issuer retrieving stored information for the corresponding permanent account number and processing an approval.

2. The method of claim 1, further comprising the issuer establishing the account for the user and issuing the permanent account number to the user.

3. The method of claim 1, wherein the patterns of digit substitution are associated with one or more restrictions including an expiration date or a maximum number of transactions.

4. The method of claim 1, further comprising: changing the one or more patterns of digit substitution at the user's request.

5. A method for authenticating payments implemented by an issuer system, comprising:
issuing to a user one or more patterns of digit substitution associated with a permanent account number and storing the patterns of digit substitution;
receiving from a merchant a request for payment approval, the request including a derivative account number and transaction information, the derivative account number having been generated by applying one of the patterns of digit substitution to the permanent account number;
based on the received derivative account number, retrieving stored information for the corresponding permanent account number; and
processing the request for approval and transmitting an approval to the merchant.

6. The method of claim 5, further comprising: changing the one or more patterns of digit substitution at the user's request.

7. The method of claim 5, further comprising storing one or more restrictions associated with some of the patterns of digit substitution, wherein the step of processing the request for approval is dependent on the associated restrictions.

8. A method for using a payment card comprising:
receiving one or more patterns of digit substitution associated with a permanent account number of the payment card;
generating a derivative account number by applying one of the patterns of digit substitution to the permanent account number; and
submitting the derivative account number to a merchant during a commerce transaction.

9. A method for authenticating an identification number comprising:
an issuer issuing to a user one or more patterns of digit substitution associated with a permanent identification number and storing the patterns of digit substitution;
the user generating a derivative identification number by applying one of the patterns of digit substitution to the permanent identification number;
the user transmitting the derivative identification number to a third party;
the third party transmitting the derivative identification number to the issuer for approval; and
based on the derivative identification number, the issuer retrieving stored information for the corresponding permanent identification number and processing an approval.
